(19) United States
(12) Patent Application Publication
(10) Pub. No.: US 2009/0172607 A1
(43) Pub. Date: Jul. 2, 2009

(54) ELECTRONIC DEVICE AND METHOD FOR CONTROLLING SCREEN SAVER OPERATIONS THEREOF

(75) Inventors: LUNG DAI, Tu-Cheng (TW); WANG-CHANG DUAN, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/269,032

(22) Filed: Nov. 11, 2008

(30) Foreign Application Priority Data
Dec. 29, 2007 (CN) 200710203556.0

(51) Int. Cl. G06F 3/048

(52) U.S. Cl. 715/867

(57) ABSTRACT

An exemplary electronic device is provided for reproducing video information and controlling screen saver operation during reproduction of the video information. The electronic device includes a content reproducing module, an input detecting module, a screen saver module, and a control module. When the control module judges that the content reproducing module is active, the screen saver module is disabled. When the control module judges that the content reproducing module is inactive and the recorded time duration has achieved the predetermined time duration, the screen saver is enabled.

### BACKGROUND

1. Technical Field

The present disclosure relates to electronic devices, and particularly to an electronic device, such as a personal computer for controlling screen saver operations during reproducing video content information.

2. Description of Related Art

Generally, electronic devices, such as personal computers (PCs) are installed with screen saver programs that can be invoked for saving electrical energy and protecting display devices of the electronic devices. A screen saver program can be initiated when a PC is idle or no input signals have been inputted for a predetermined period of time. The screen saver program is invoked by blanking out the information displayed on the display devices or replacing the displayed information by other images.

However, most screen saver programs check for keyboard inputs and when viewing video files such as movies the screen saver program may activate because of the lack of keyboard inputs and the images of the video may be blanked out or replaced by other images invoked by the screen saver programs. Although the problem can be solved by deactivating the screen saver program prior to viewing the video files, this is an inconvenience because the screen saver program must be manually activated before and after viewing the video files.

Therefore, providing an electronic device and a method for controlling screen saver operations during reproducing video information are desired.

### SUMMARY

Accordingly, an electronic device is provided for reproducing video information and controlling screen saver operations during reproduction of the video information. The electronic device includes a content reproducing module, an input detecting module, a screen saver module, and a control module. The content reproducing module is configured for reproducing video information, and causing the video information to be displayed on a screen of the electronic device. The input detecting module is configured for detecting and recording a time duration that no input signals have been received by the electronic device. The screen saver module is configured for executing a screen saver program after the electronic device is not operated for a predetermined time duration. The control module is coupled to the content reproducing module, the input detecting module, and the screen saver. The control module is configured for judging whether the content reproducing module is active or not, and receiving the recorded time duration that an input signals have been received by the electronic device. When the control module judges that the content reproducing module is active the screen saver module is disabled. When the control module judges that the content reproducing module is inactive and the received recorded time duration has achieved the predetermined time duration, the screen saver is enabled.

Other advantages and novel features will become more apparent from the following detailed description of exemplary embodiment when taken in conjunction with the accompanying drawings.

### BRIEF DESCRIPTION OF THE DRAWINGS

FIG. 1 is a block diagram of an electronic device in accordance with an exemplary embodiment.

FIG. 2 is a detailed block diagram of an electronic device in accordance with another exemplary embodiment.

FIG. 3 is a flowchart illustrating various actions of a method in accordance with a first exemplary embodiment which may be performed by the electronic device in FIG. 1 or FIG. 2 to control screen saver operations thereof.

FIG. 4 is a flowchart illustrating various actions of a method in accordance with a second exemplary embodiment which may be performed by the electronic device in FIG. 1 or FIG. 2 to control screen saver operations thereof.

FIG. 5 is a flowchart illustrating various actions of a method in accordance with a third exemplary embodiment which may be performed by the electronic device in FIG. 1 or FIG. 2 to control screen saver operations thereof.

FIG. 6 is a flowchart illustrating various actions of a method in accordance with a fourth exemplary embodiment which may be performed by the electronic device in FIG. 1 or FIG. 2 to control screen saver operations thereof.

### DETAILED DESCRIPTION

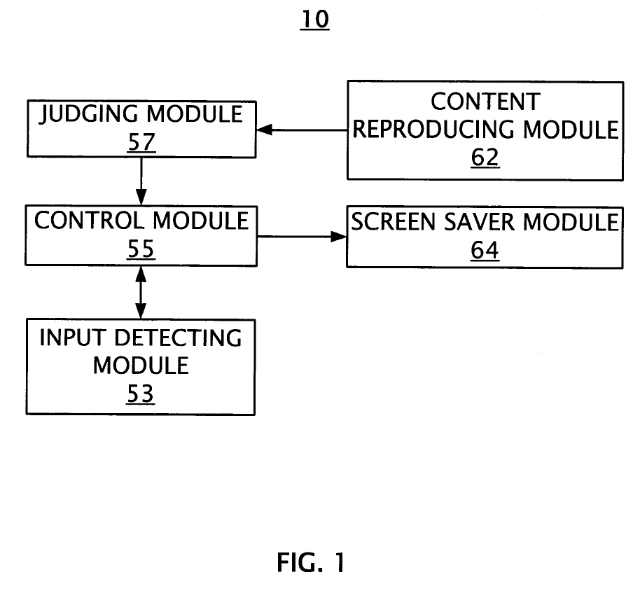

Referring to FIG. 1, an electronic device 10 in accordance with an exemplary embodiment is illustrated. The electronic device 10 may be a personal computer (PC), a portable/notebook/laptop computer, and/or a digital television (DTV).

The electronic device 10 includes an input detecting module 53, a control module 55, a judging module 57, a content reproducing module 62, and a screen saver module 64. It is possible that other modules such as a display module (liquid crystal display, LCD), a memory module (random access memory, RAM, or read only memory, ROM) can be included in the electronic device 10.

The control module 55 is coupled to the input detecting module 53, the judging module 57, and the screen saver module 64. The content reproducing module is coupled to the judging module 57.

The input detecting module 53 is configured for detecting input signals and clocking and recording a time duration that the electronic device 10 does not receive the input signals. The input signals may be from an input device, such as a keyboard and/or a mouse (not shown) associated with the electronic device 10. Specifically, the input detecting module 53 may be a timer, which can be triggered for timing and recording the time duration. The input detecting module 53 is further configured for transmitting the recorded time duration to the control module 55.

The screen saver module 64 is configured for invoking a screen saver program stored in the memory module of the electronic device 10 or transmitted from other electronic devices via a network. The screen saver module 64 is signaled by the control module 55 to invoke the screen saver program. When the screen saver program is invoked and implemented, data graphics displayed by the electronic device 10 may be totally blanked out or replaced by other data graphics for conserving electrical energy.

The control module 55 receives the recorded time duration transmitted from the input detecting module 53. Then, the control module 55 compares the recorded time duration with predetermined time duration for determining whether the screen saver module 64 should be triggered to implement the screen saver program. When the recorded time duration is the same as the predetermined time duration, the screen saver module 64 may be signaled to invoke the screen saver program. When the recorded time duration has not yet reached the predetermined time duration, the screen saver program is not invoked by the screen saver module 64. It should be noted that the predetermined time duration is modifiable according to a user's preference.

The content reproducing module 62 is configured for implementing video decoding program. The video decoding program can be implemented to decode video files stored in the electronic device 10, and to generate decoded video information. The decoded video information may be transmitted to and displayed by the display device (not shown) of the electronic device 10.

When the content reproducing module 62 is active, a reproduce video signal is transmitted to the judging module 57. Herein, the term “active” means that the video decoding program is continuously kept running by the content reproducing module 62, and, furthermore, a display window for displaying the decoded video information is activated.

In many circumstances, the content reproducing module 62 is inactive. As a first example, the content reproducing module 62 may buffer video files from the internet. During a buffer time when the 62 is buffering the video files, the content reproducing module 62 is inactive, because the video decoding program is not running.

As a second example, the content reproducing module 62 may be paused for some reasons, such as when the electronic device 10 needs to perform other tasks and/or processes. In such a pause time, the content reproducing module 62 is also inactive, because the video decoding program is not running or not invoked.

As a third example, when a video decoding software, such as RealPlayer® or Windows Media Player® is invoked by the electronic device 10, a display window for displaying the decoded video information may be minimized, and the video is not displayed. In this situation, although the video decoding program was implemented by the content reproducing module 62, the content reproducing module 62 is inactive because the decoded video information is not being displayed.

The judging module 57 receives the video reproduce signal from the content reproducing module 62, and detects the status of the content reproducing module 62. When the judging module detects that the status of the content reproducing module 62 is active, the judging module 57 transmits a suspend screen saver signal to the control module 55. When the judging module judges that the status of the content reproducing module is inactive, the judging module 57 transmits an enable screen saver signal to the control module 55.

When the enable screen saver signal is received from the judging module 57, that is, after the recorded time duration has reached the predetermined time duration, the control module 55 initiates the screen saver module 64 to implement the screen saver program. Also, the content reproducing module 62 can be configured to disable or pause the video decoding program when the screen saver program has been detected to be active. If the recorded time duration has not reached the predetermined time duration, the screen saver program may not be invoked even if the control module 55 receives the enable screen saver signal.

The control module 55 signals the screen saver module 64 to suspend the screen saver program, after the suspend screen saver signal is received from the judging module 57. At the same time, a reset signal is transmitted from the control module 55 to the input detecting module 53. The input detecting module 53 resets the time duration to zero after receiving the reset signal.

As mentioned above, the screen saver program is not invoked when the electronic device 10 reproduces the video information. As soon as the content reproducing module 62 stops reproducing the video information, and no input signals has been received by the electronic device 10 during the predetermined time duration, the screen saver program activates to conserve electrical energy and protect the display device. Therefore, the screen saver program does not need to be manually invoked, and better video entertainment can be provided.

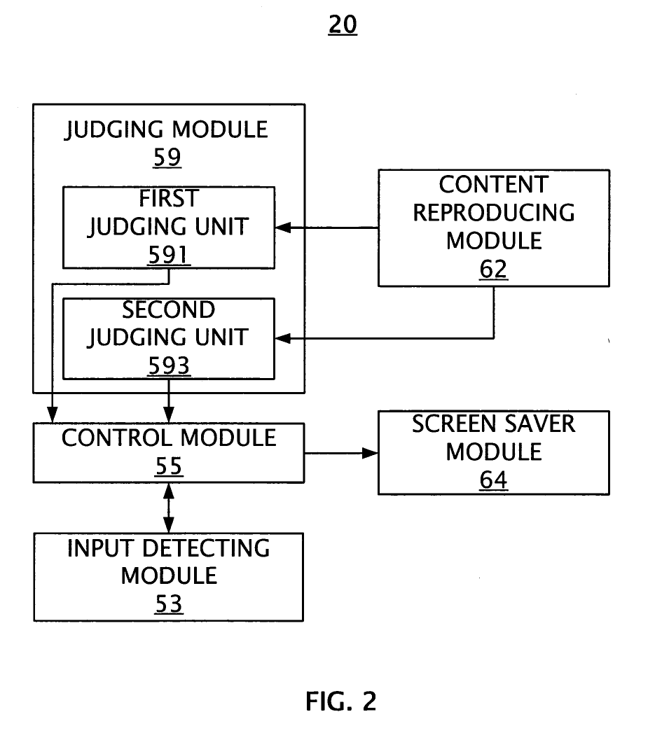

Referring to FIG. 2, a detailed block diagram of an electronic device 20 in accordance with another exemplary embodiment is illustrated. The electronic device 20 has similar configurations with the electronic device 10 illustrated in FIG. 1. For example, the electronic device 20 includes the input detecting module 53, the control module 55, the content reproducing module 62, and the screen saver module 64 that are similar to corresponding components of the electronic device 10. The electronic device 20 further includes a judging module 59, which is different from the judging module 57 of the electronic device 10. The judging module 59 will be described as below.

The judging module 59 is configured for determining if the content reproducing module 62 is active or not. The judging module 59 includes a first judging module 591 and a second judging module 593 that are both coupled to the content reproducing module 62. The first judging module 591 and the second judging module 593 are also both coupled to the control module 55.

More specifically, the first judging module 591 is configured for receiving a first reproducing state signal from the content reproducing module 62 for determining whether the video decoding program is implemented by the content reproducing module 62 or not. The second judging module 593 is configured for receiving a second reproducing state signal from the content reproducing module 62 for determining whether a display window for displaying decoded video information is activated or not.

When the first judging module 591 judges that the video decoding program is implemented by the content reproducing module 62, the first judging module 591 transmits a first screen saver suspending signal to the control module 55. When the first judging module 591 judges that the video decoding program is not implemented by the content reproducing module 62, the first judging module 591 transmits a first screen saver enabling signal to the control module 55.

When the second judging module 593 judges that the display window for displaying the decoded video information is not activated in the electronic device 10, the second judging module 593 transmits a second screen saver suspending signal to the control module 55. When the second judging module 593 judges that the display window for displaying the decoded video information is activated in the electronic device 10, the second judging module 593 transmits a second screen saver enabling signal to the control module 55.

When both the first and second screen saver enabling signals are received from the first judging module 591 and the second judging module 593 respectively, and the recorded time duration received from the input detecting module 53 has reached the predetermined time duration, the control module 55 initiates the screen saver module 64 to implement the screen saver program.

When either the first screen saver suspending signal is received from the first judging module 591, or the second screen saver suspending signal is received from the second judging module 593, the control module 55 disables the screen saver module 64, such that the screen saver program is not invoked. At the same time, a reset signal is initiated in the control module 55, and transmitted to the input detecting module 53. When no input signals has been inputted to the electronic device 10, the input detecting module 53 resets the time duration to zero according to the reset signal. The content reproducing module 62 can be configured to disable or pause the video decoding program upon determination that the screen saver program is implemented.

As mentioned above, the screen saver program is also implemented automatically to conserve electrical energy and protect the display device. Therefore, the user does not need to manually disable the screen saver program.

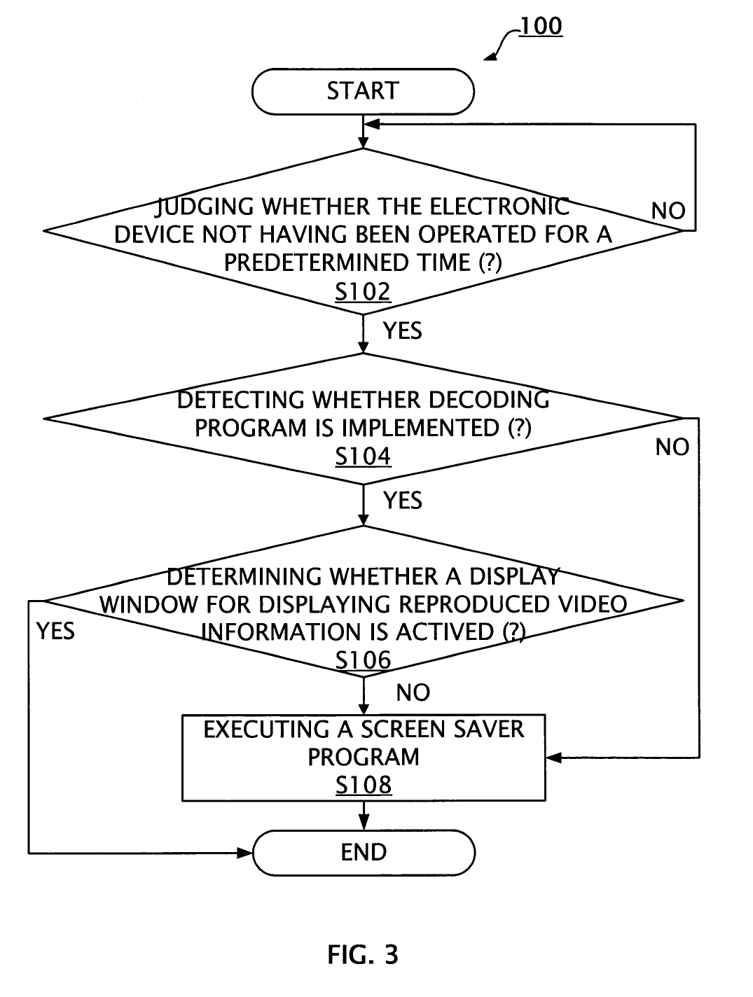

Referring to FIG. 3, a method 100, of controlling screen saver operations of the electronic device 10 or the electronic device 20 during video information being reproduced, is illustrated. The method 100 includes the following steps.

At step S102, the input detecting module 53 of the electronic device 10 determines whether the electronic device 10 has been operated for a predetermined time duration. More specifically, the input detecting module 53 detects and records a time duration during which no input signals has been inputted to the electronic device 10. The procedure loops back to the start when the recorded time duration has not reached the predetermined time duration.

At step S104, when the recorded time duration has reached the predetermine time duration, the judging module 57 of the electronic device 10 determines if a content reproducing module is active. At this step S104, when the recorded time duration has reached the predetermine time duration, the first judging module 591 of the electronic device 20 judges whether a video decoding program is implemented by the content reproducing module 62.

At step S106, when the video decoding program is implemented by the content reproducing module 62, the judging module 57 judges whether the display window is activated in the electronic device 10. At this step S106, when the video decoding program is implemented by the content reproducing module 62, the second judging module 591 of the electronic device 20 judges whether the display window is activated in the electronic device 20.

At step S108, when the video decoding program is not implemented by the content reproducing module 62, the screen saver module 64 executes the screen saver program.

When the display window is activated, the procedure ends. In this circumstance, the video content can be reproduced without being disturbed by the activated screen saver program.

The various actions in the method 100 may be performed in the order presented, or may be performed in a different order. Furthermore, in some embodiments, the step S106 illustrated in FIG. 3 may be omitted from the method 100.

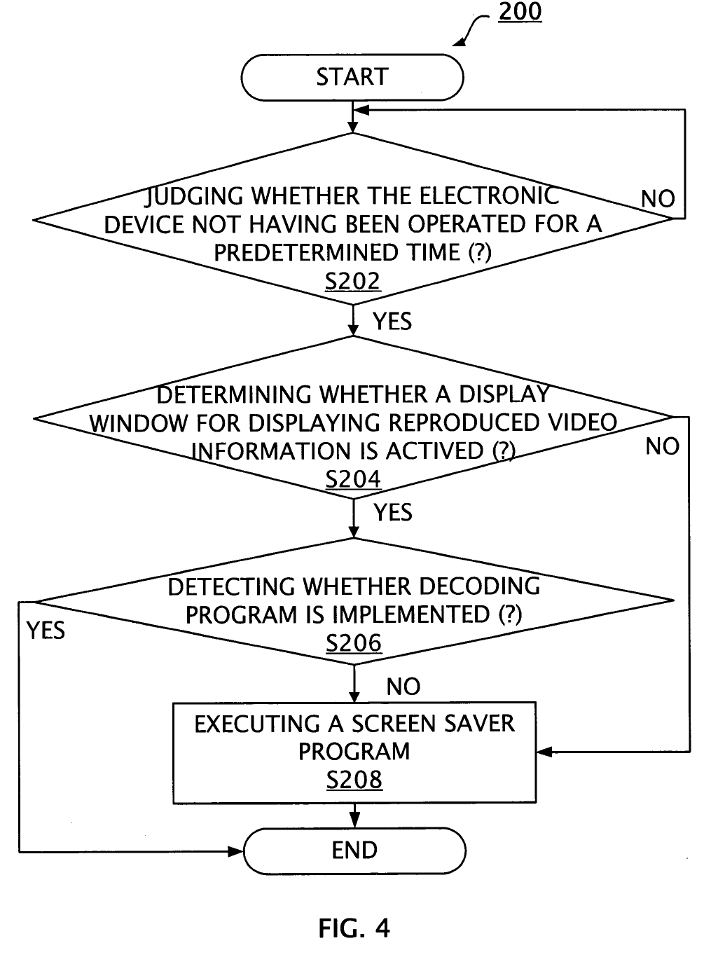

Referring to FIG. 4, a method 200, of controlling screen saver operations of the electronic device 10 or the electronic device 20 during video information being reproduced, is illustrated. The method 200 includes the following steps.

At step S202, the input detecting module 53 of the electronic device 10 determines whether the electronic device 10 has not been operated for a predetermined time duration. More specifically, the input detecting module 53 detects and records a time duration that no input signals have been inputted to the electronic device 10. When the recorded time duration has not reached the predetermined time duration, the procedure loops back to the start.

At step S204, when the recorded time duration has reached the predetermine time duration, the judging module 57 of the electronic device 10 judges whether a display window for displaying the decoded video information is activated. At this step S204, when the recorded time duration has reached the predetermine time duration, the second judging module 593 of the electronic device 20 determines whether a display window for displaying the decoded video information is activated.

At step S206, when the display window is activated, the judging module 57 of the electronic device 10 determines whether the video decoding program is implemented by the content reproducing module 62 or not. At this step S206, when the display window is activated, the first judging module 591 of the electronic device 20 determines whether the video decoding program is implemented by the content reproducing module 62.

At step S208, when the display window for displaying the decoded video information is not activated, the screen saver module 64 executes the screen saver program.

When the video decoding program is implemented in the electronic device 10 or the electronic device 20, the procedure ends and the screen saver program is not invoked. In this circumstance, the video content can be reproduced without being disturbed by the activated screen saver program.

It should be noted that the various actions in the method 200 may be performed in the order presented, or may be performed in a different order. Furthermore, in some embodiments, the step S206 listed in FIG. 4 may be omitted from the method 200.

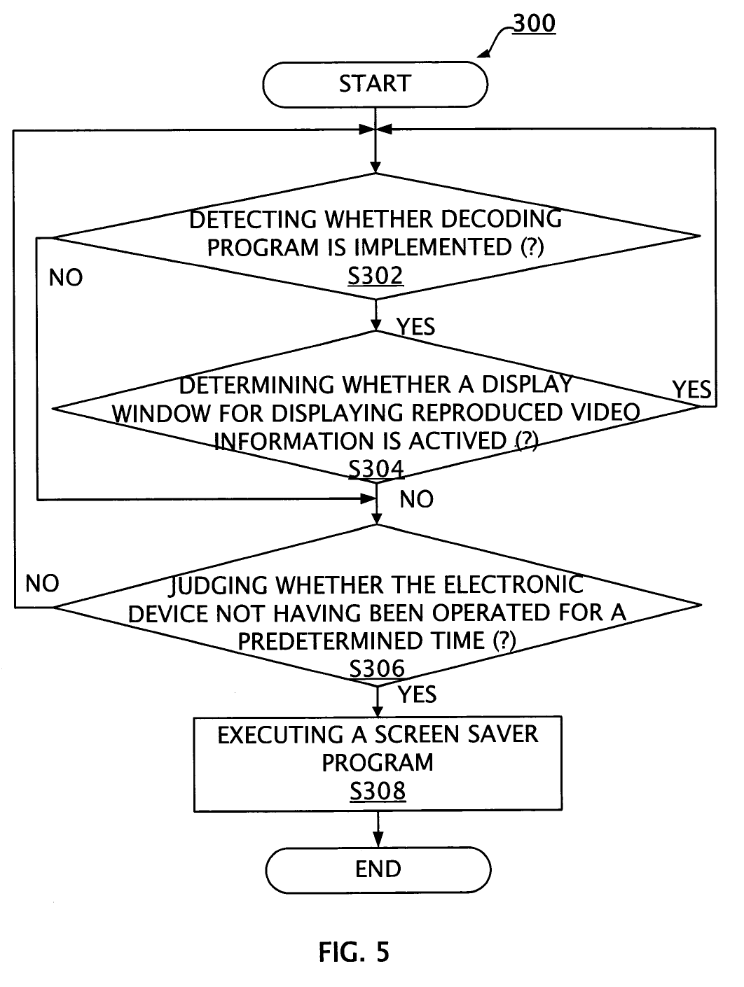

Referring to FIG. 5, a method 300, of controlling screen saver operations of the electronic device 10 or the electronic device 20 when video information is reproduced, is illustrated. The method 300 includes the following steps.

At step S302, for the electronic device 10, the judging module 57 judges whether the video decoding program is implemented by the content reproducing module 62 or not. At this step S302, for the electronic device 20, the first judging module 591 of the electronic device 20 determines whether the video decoding program is implemented by the content reproducing module 62.

At step S304, for electronic device 10, when the video decoding program is implemented by the content reproducing module 62, the judging module 57 judges whether the display window is activated. At this step S304, for electronic device 20, when the video decoding program is implemented by the content reproducing module 62, the second judging module 593 of the electronic device 20 judges whether the display window is activated. When the display window is activated, the procedure loops back to the start.

At step S306, when the display window is activated, the input detecting module 53 determines whether a predetermined time duration has been reached during a time duration that no input signals have been inputted to the electronic device 10 or the electronic device 20. When the predetermined time duration has not reached the time duration and no input signals have been inputted to the electronic device 10 or the electronic device 20, the procedure goes to the step S302.

At step S308, when the time duration has reached the predetermined time duration, the screen saver module 64 executes the screen saver program for conserving electrical energy.

It should be noted that the various actions in the method 300 may be performed in the order presented, or may be performed in a different order. Furthermore, in some embodiments, the step S302 illustrated in FIG. 5 may be omitted from the method 300.

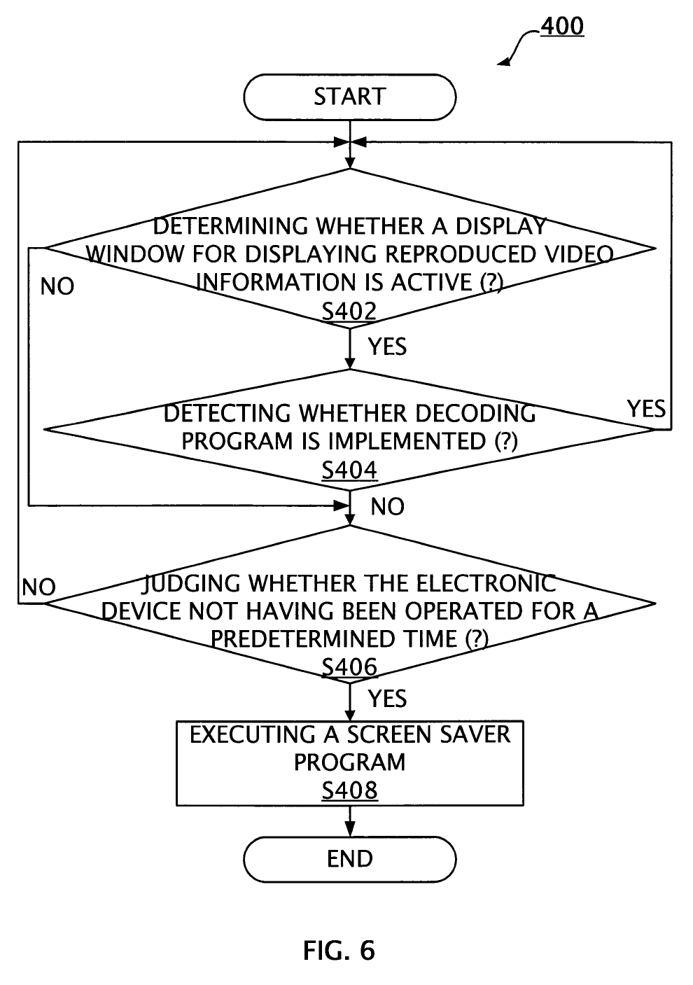

Referring to FIG. 6, a method 400, of controlling screen saver operations of the electronic device 10 or the electronic device 20 during video information being reproduced, is illustrated. The method 400 includes the following steps.

At step S402, for electronic device 10, the judging module 57 judges whether the display window is activated. At this step S402, for electronic device 20, the second judging module 593 judges whether the display window is activated or not.

At step S404, for electronic device 10, when the display window is activated, the judging module 57 judges whether the video decoding program is implemented by the content reproducing module 62. At this step S404, for electronic device 20, when the display window is activated, the first judging module 591 determines whether the video decoding program is implemented by the content reproducing module 62. When the video decoding program is implemented, the procedure goes to the start.

At step S406, either upon determination that the display window is not activated or the video decoding program is not implemented, the input detecting module 53 determines whether the time duration has reached a predetermined time duration. The predetermined time duration is preconfigured in the electronic device 10 or the electronic device 20. The time duration is a time period that no input signals have been inputted to the electronic device 10 or the electronic device 20.

At step S408, when the time duration has reached the predetermined time duration, the screen saver module 64 executes a screen saver program for saving electrical energy and protecting the display device.

It should be noted that the various actions in the method 400 may be performed in the order presented, or may be performed in a different order. Furthermore, in some embodiments, the step S402 listed in FIG. 6 may be omitted from the method 400. Therefore, the user does not need not to manually disable the screen saver program.

As the method 100, 200, 300, and 400 described above for controlling screen saver operations during the video content being reproduced, the screen saver is automatically disabled upon determination that the video content is reproduced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electronic device for reproducing video information and controlling screen saver operation during reproduction of the video information, the electronic device comprising:
a content reproducing module for reproducing video information, and causing the video information to be displayed on a screen of the electronic device;
an input detecting module for detecting and recording a time duration that no input signals have been received by the electronic device;
a screen saver module for executing a screen saver program stored in the electronic device after the electronic device has not received any inputs for a predetermined time duration; and
a control module coupled to the content reproducing module, the input detecting module, and the screen saver, the control module configured for judging whether the content reproducing module is active or not, and receiving the recorded time duration that no input signals have been received by the electronic device;
wherein when the control module judges that the content reproducing module is active, the screen saver module is disabled; and when the control module judges that the content reproducing module is inactive and the recorded time duration has reached the predetermined time duration the screen saver is enabled.

2. The electronic device according to claim 1, wherein the control module judges the content reproducing module to be active upon determination that video decoding programs are implemented by the content reproducing module.

3. The electronic device according to claim 1, wherein the control module judges the content reproducing module to be active upon determination that video decoding programs are implemented by the content reproducing module, and a display window for displaying the decoded video information is activated, the control module disables the screen saver module in response to the content reproducing module being judged to be active.

4. The electronic device according to claim 1, further comprising a judging module coupled between the control module and the content reproducing module, the judging module being configured for judging whether the content reproducing module is active.

5. The electronic device according to claim 4, wherein the judging module comprising:
a first judging module coupled between the content reproducing module and the control module, the first judging module configured for judging whether the video decoding programs are implemented by the content reproducing module; and
a second judging module coupled between the content reproducing module and the control module, the second judging module being configured for judging whether the display window for displaying the decoded video information is activated by the content reproducing module.

6. A method for controlling screen saver operations during video information being reproduced by an electronic device, the method comprising:
(a) detecting and recording a time duration that no input signals have been inputted to the electronic device;
(b) determining whether the recorded time duration has reached a predetermined time duration preconfigured in the electronic device;
(c) detecting a reproducing state of whether video content being reproduced by the electronic device upon determination that the time duration has reached the predetermined time duration that no input signals have been inputted to the electronic device;
(d) suspending a screen saver program when the reproducing state is detected to be active and the video content is reproduced by the electronic device; and
(e) implementing the screen saver program when the reproducing state is detected to be inactive and the video content is not reproduced by the electronic device.

7. The method according to claim 6, wherein the step (c) comprises:
detecting whether video decoding programs being implemented by the electronic device.

8. The method according to claim 7, further comprising:
suspending the screen saver program when the video decoding programs are detected being implemented by the electronic device; and
implementing the screen saver program when the video decoding programs are detected not being implemented by the electronic device.

9. The method according to claim 6, wherein the step (c) comprises:
detecting whether the display window for displaying the decoded video information is activated by the electronic device.

10. The method according to claim 9, further comprising:
suspending the screen saver program when the display window for displaying the decoded video information is activated by the electronic device; and
implementing the screen saver program when the display window for displaying the decoded video information is not activated by the electronic device.

11. The method according to claim 10, further comprising:
disabling the video decoding programs upon determination that the screen saver program being implemented.

12. The method according to claim 6, further comprising:
resetting the time duration to zero upon determination that the screen saver program is not invoked.

13. A method for controlling screen saver operations during video information being reproduced by an electronic device, the method comprising:
(a) detecting a reproducing state of whether video content being reproduced by the electronic device;
(b) detecting and recording a time duration that no input signals have been inputted to the electronic device upon determination that the reproducing state being detected is inactive;
(c) determining whether the recorded time duration has reached a predetermined time duration preconfigured in the electronic device;
(d) suspending a screen saver program upon determination that the time duration has not reached the predetermined time duration that no input signals have been inputted to the electronic device; and
(e) implementing the screen saver program upon determination that the time duration has reached the predetermined time duration that no input signals have been inputted to the electronic device.

14. The method according to claim 13, wherein the step (a) comprises:
detecting whether video decoding programs being implemented by the electronic device.

15. The method according to claim 14, further comprising:
suspending the screen saver program when the video decoding programs are detected being implemented by the electronic device; and
implementing the screen saver program when the video decoding programs are detected not being implemented by the electronic device.

16. The method according to claim 13, wherein the step (a) comprises:
detecting whether a display window for displaying the decoded video information is activated by the electronic device.

17. The method according to claim 16, further comprising:
suspending the screen saver program when the display window for displaying the decoded video information is not activated by the electronic device; and
implementing the screen saver program when the display window for displaying the decoded video information is activated by the electronic device.

18. The method according to claim 13, further comprising:
disabling the video decoding programs upon determination that the screen saver program being implemented.

19. The method according to claim 13, further comprising:
resetting the time duration to zero upon determination that the screen saver program is not invoked.
